(19) United States
(12) Patent Application Publication
(10) Pub. No.: US 2018/0150498 A1
(43) Pub. Date: May 31, 2018

(54) DATABASE MANAGEMENT DEVICE, INFORMATION PROCESSING SYSTEM, AND DATABASE MANAGEMENT METHOD

(71) Applicant: FUJITSU LIMITED, Kawasaki-shi (JP)

(72) Inventor: Toshihiro SHIMIZU, Sagamihara (JP)

(73) Assignee: FUJITSU LIMITED, Kawasaki-shi (JP)

(21) Appl. No.: 15/693,886

(22) Filed: Sep. 1, 2017

(30) Foreign Application Priority Data
Nov. 25, 2016 (JP) 2016-229041

(51) Int. Cl. G06F 17/30

(52) U.S. Cl. CPC G06F 17/30356; G06F 17/30362; G06F 17/30002

(57) ABSTRACT

A database management device includes: a memory that stores a database management program; and a processor that executes processing based on the database management program, wherein the processor: accepts a table definition to which permission information is added, the permission information allowing one or more columns included in a table to be updated once; stores management information on the table and the permission information in a management information storage; and updates the table by a write-once scheme or a rewriting scheme based on the permission information.

### CROSS-REFERENCE TO RELATED APPLICATION

This application is based upon and claims the benefit of priority of the prior Japanese Patent Application No. 2016-229041, filed on Nov. 25, 2016, the entire contents of which are incorporated herein by reference.

### FIELD

The embodiments discussed herein are related to a database management device, an information processing system, and a database management method.

### BACKGROUND

A database management system includes a function of multi-version concurrency control (MVCC). The MVCC is a mechanism in which a content, when there are simultaneous accesses by a plurality of transactions, is caused to look differently for each of the transactions.

The related art is discussed in Japanese Laid-open Patent Publication No. 2009-271665, Japanese Laid-open Patent Publication No. 2003-162438, or Japanese Laid-open Patent Publication No. 2008-181297.

### SUMMARY

According to an aspect of the embodiments, a database management device includes: a memory that stores a database management program; and a processor that executes processing based on the database management program, wherein the processor: accepts a table definition to which permission information is added, the permission information allowing one or more columns included in a table to be updated once; stores management information on the table and the permission information in a management information storage; and updates the table by a write-once scheme or a rewriting scheme based on the permission information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates exemplary update of a record by a database management device;

FIG. 2 illustrates an exemplary information processing system;

FIG. 3 illustrates exemplary management information on column of a table;

FIG. 4 illustrates an exemplary data structure of a record including rewritable columns;

FIG. 5 illustrates exemplary processing in which a rewritable column is determined;

FIG. 6 illustrates exemplary record update processing;

FIG. 7 illustrates exemplary record reference processing;

FIG. 8 illustrates a determination example of visibility of a rewritable column;

FIG. 9 illustrates an exemplary hardware configuration of a computer that executes a database management program;

FIG. 10 illustrates exemplary MVCC;

FIG. 11 illustrates exemplary write-once MVCC; and

FIG. 12 illustrates exemplary write-once MVCC.

### DESCRIPTION OF EMBODIMENTS

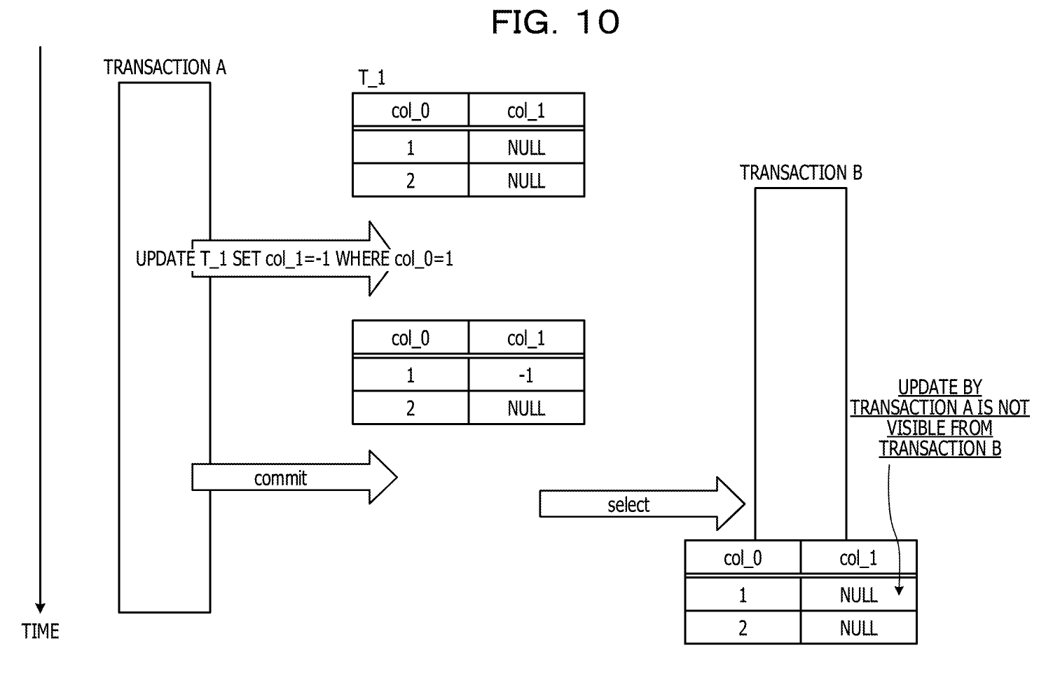

FIG. 10 illustrates exemplary MVCC. In FIG. 10, appearance of data in the MVCC is illustrated. In FIG. 10, during execution of a transaction A in which a table T_1 is updated, the table T_1 is referred to by a transaction B. As illustrated in FIG. 10, in the transaction A, through an UPDATE statement, “col_1” of a record in which “col_0” is 1 is updated to “−1”. Here, “col_1” of the first row of “T_1” is updated from “NULL” to “−1”. In addition, in the transaction A, the update is committed.

In the transaction B, “T_1” is referred to by “select” before the processing of the transaction A ends. At that time, there are accesses to “T_1” from both of the transaction A and the transaction B, and thus the update by the transaction A is not viewed from the transaction B. For example, “col_1” of the first row of “T_1” viewed from the transaction B is “NULL”.

For concurrency control, a lock mechanism may be used. As compared with the lock mechanism, the MVCC may have an advantage in that acquisition of read lock and acquisition of write lock do not compete with each other.

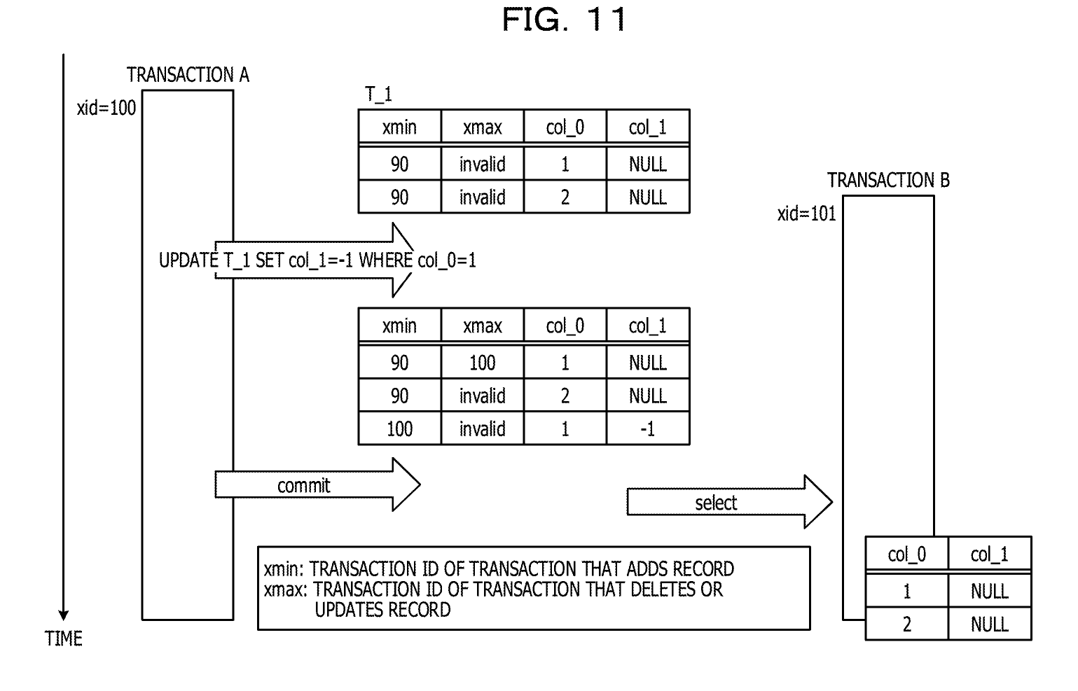

The MVCC includes write-once MVCC. In the write-once MVCC, the content is not rewritten at the time of update of table data, but data after the update is added to a table. FIG. 11 illustrates exemplary write-once MVCC. In FIG. 11, “xid” indicates a transaction ID used to identify each transaction.

As illustrated in FIG. 11, “T_1” includes columns of “xmin” and “xmax”, in addition to the “col_1” and “col_2”. “xmin” indicates a transaction ID of a transaction in which addition of a record has been performed. “xmax” indicates a transaction ID of a transaction in which deletion of a record has been performed or update of record has been performed.

For example, the first row of “T_1” has been added to “T_1” by a transaction the transaction ID of which is 90. “invalid” indicates the initial value of “xmax” and indicates that deletion or update of a record is not performed. When, in the transaction A the transaction ID of which is 100, the first row is updated through the UPDATE statement, “xmax” of the first row is updated to 100, and the third row is added to “T_1”. For example, a record in which “col_1” is updated to “−1” is added to “T_1”.

The write-once MVCC may have an advantage in that reading and writing of rows do not conflict, a pointer operation desired when updated data is stored in another area is unnecessary, or the like.

For example, an item on which processing is executed by a plurality of transactions input is searched for once. For the searched item, update processing by the plurality of transactions is sequentially executed in a main memory, and only the last-updated result is written into a database. In such a technique, a plurality of transactions may be processed efficiently.

For example, a database management system includes external files which store non-ordinary operation data such as long data, an external file management unit that manages the external files, and an external file list storage file that stores a list of the external files. In the database management system, in addition to a file in a base page area that stores the oldest version of a page, the external file and the external file list storage file are accessed directly, and backup is performed. Therefore, in the database management system, the backup may be performed in a simple work process in which files that constitute a database are accessed directly even in a normal operation state where users execute a plurality of transactions.

For example, in a case in which a ratio of the size of an unnecessary area generated in the database due to update or deletion of data to the size of an unnecessary area in the page exceeds a threshold value, when data that belongs to the unnecessary area in the page is released from the position of the unnecessary area, unnecessary area repair processing may be executed efficiently.

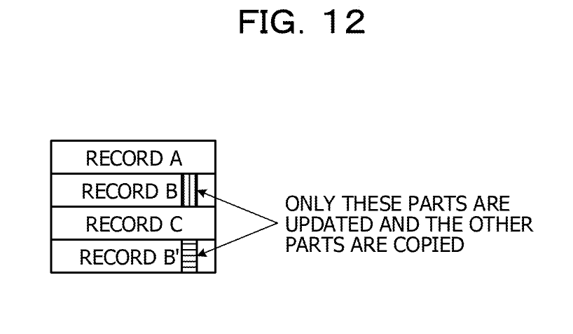

In the write-once MVCC, in a case in which data are updated, even when only some of the data are updated, the whole record is copied, and therefor the overhead of the copy may be large. FIG. 12 illustrates exemplary write-once MVCC. As illustrated in FIG. 12, when a record B is updated to a record B′, even in the case where the updated portion is a small portion in the whole record, the whole record B is copied, and the overhead may be increased.

For example, in the write-once MVCC, processing to reuse an invalid area that has become invalid after deletion or update in a record such as the record B is executed, but the overhead of the processing for the reuse of the invalid area may be large.

For example, the overhead of the write-once MVCC may be reduced.

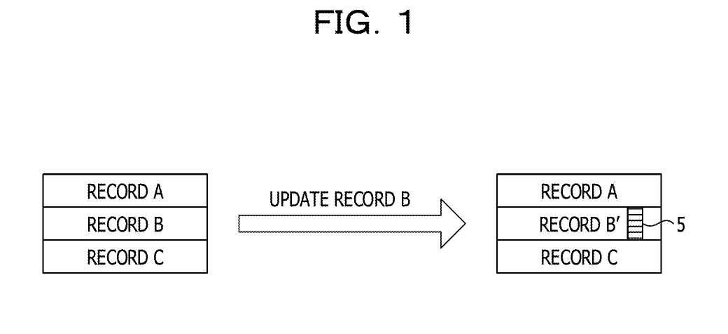

FIG. 1 illustrates exemplary update of a record by a database management device. As illustrated in FIG. 1, in the case where the database management device updates some data of a record B, the database management device rewrites part of the record B and sets the record B as a record B′. In FIG. 1, an update part 5 indicates the rewritten part.

For example, data which is to be rewritten is limited, and update by the rewriting is allowed to be performed only on data the length of which is fixed and on which update is performed only once. When the size of data becomes large due to the update, it is difficult to rewrite an area in which the data is stored with the update data. When the update is performed only once, a value before the update is a default value or non-definition value, so that storage of the past data is unnecessary, but when the update is performed twice or more, storage of the past data is desired.

In the case where the update is performed only on data the length of which is fixed and on which update is performed only once, the database management device may reduce the overhead of copy of the whole record by performing rewriting of the data.

For example, examples of the data on which update is performed once include sales data including a purchase customer ID, a purchase customer name, a purchase date, a purchase store name or the like of a product. All of the purchase customer ID, the purchase customer name, the purchase date, the purchase store name, and the like, may not be input at once at the time of registration of the data due to lack of some data, and some data may be added later.

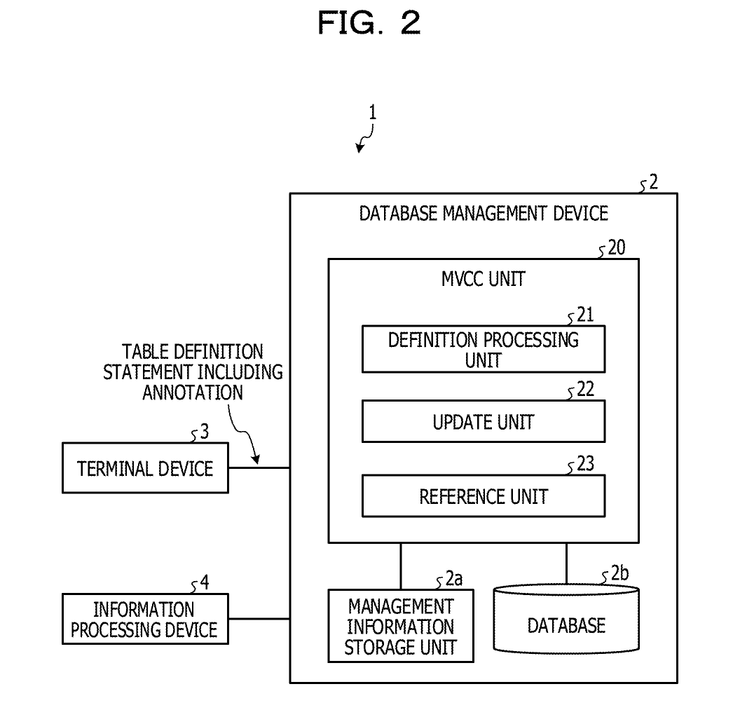

FIG. 2 illustrates an exemplary information processing system. As illustrated in FIG. 2, an information processing system 1 includes a database management device 2, a terminal device 3, and an information processing device 4.

For example, the database management device 2 may be a relational database management device including a function of write-once MVCC. The database management device 2 may store data used by the information processing device 4 as a relational database.

The terminal device 3 may be a device used for management of a database. The terminal device 3 accepts a table definition statement including an annotation, from a database administrator, and transmits the table definition statement to the database management device 2. For example, the table definition statement including the annotation may be a table definition statement that specifies by the annotation that a column is allowed to be updated only once.

An example of the table definition statement that specifies by the annotation that a column is allowed to be updated only once is described below.

CREATE TABLE<tablename> (<coldef>+)<coldef>::=<colname> <type> <annotation>| . . .

“CREATE TABLE” indicates that the statement is a definition of a table. “<tablename>” is a name of the table on which the definition is performed. “<coldef>+” indicates that there are one or more definitions of a column. “<coldef>::=” indicates a definition of the column. “<colname>” is the name of the column. “<type>” is a data type of the column. “<annotation> | . . .” indicates that there may be more than one annotation.

For example, “CREATE TABLE t (col_0 int, col_1 int linear)” defines that “col_1” of “table t” is allowed to be updated only once. In addition, “linear” is an annotation that specifies that the update is allowed to be performed only once. For example, “linear” is an example, and another word may be used as an annotation that specifies that the update is allowed to be performed only once.

The information processing device 4 may be a device that executes information processing, and uses data managed by the database management device 2. For convenience of explanation, only a single information processing device 4 is illustrated, but a plurality of information processing devices 4 may use data managed by the database management device 2.

The database management device 2 includes a management information storage unit 2a, a database 2b, and a MVCC unit 20. The management information storage unit 2a stores information used to manage the database 2b. For example, the management information storage unit 2a stores management information on the whole table, management information on columns of the table, and the like. The management information on the whole table and the management information on the columns of the table may be collectively referred to as table management information.

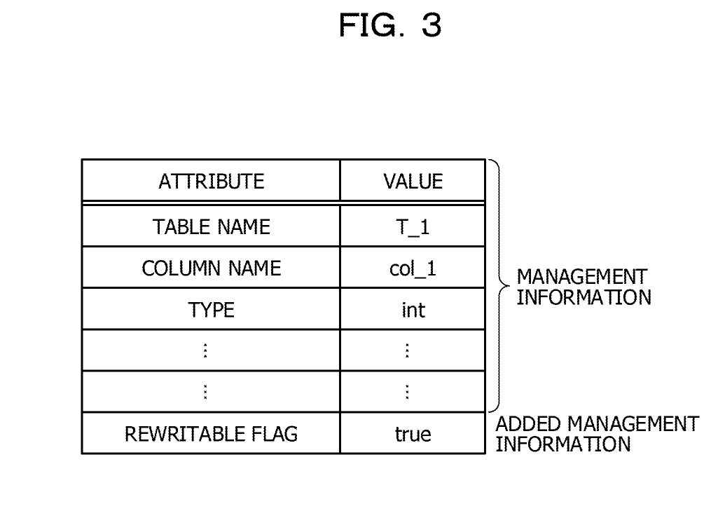

FIG. 3 illustrates exemplary management information on columns of a table. As illustrated in FIG. 3, examples of the management information on the columns of the table include values of attributes such as a table name, a column name, a type, and a rewritable flag. The table name is a name of a table to which the column belongs, and is, for example, “T_1”. The column name is a name by which the column is identified, and is, for example, “col_1”. The type is a data type of the column, and is, for example, “int” (integer). Each of the table name, the column name, the type, and the like, is information stored as the management information on the columns by the database management device.

The rewritable flag is information indicating whether the column is rewritable. The value is “true” or “false”. When the value is “true”, the column is rewritable, and when the value is “false”, the column is not rewritable. The rewritable flag is management information that has bene added for the column in the database management device 2.

The database 2b stores data used by the information processing device 4, for example, a table. The table includes one or more records. The record may include a rewritable column.

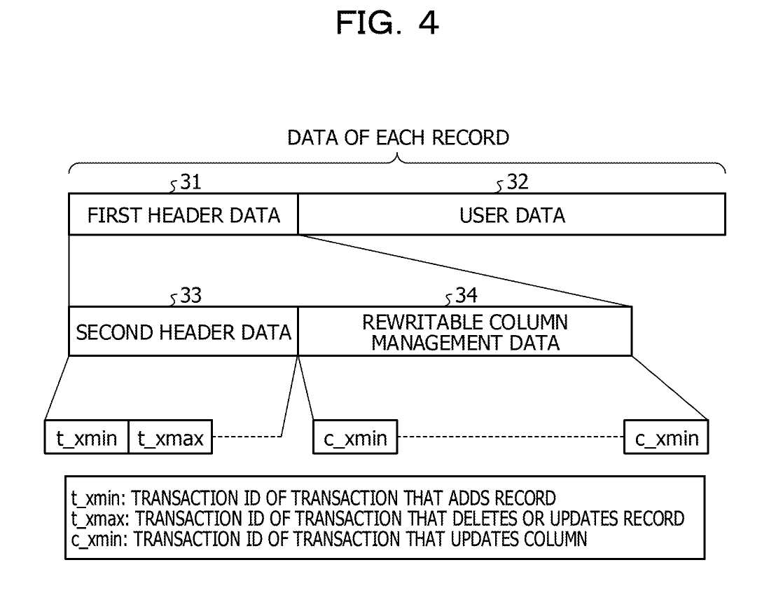

FIG. 4 illustrates an exemplary data structure of a record including a rewritable column. As illustrated in FIG. 4, a record includes first header data 31 and user data 32. The first header data 31 is data related to the record, and the user data 32 is data for one row of a table.

The first header data 31 includes second header data 33 and rewritable column management data 34. For example, the second header data 33 includes “t_xmin” and “t_xmax”. The second header data 33 may be data included in header data of a conventional database management device.

“t_xmin” is a transaction ID of a transaction that adds a record, and “t_xmax” is a transaction ID of a transaction that deletes a record or updates a record.

The rewritable column management data 34 is data used to manage rewritable columns, and includes “c_xmin” for each of the rewritable columns. “c_xmin” is a transaction ID of a transaction that updates a corresponding column.

The MVCC unit 20 performs MVCC. The MVCC unit 20 includes a definition processing unit 21, an update unit 22, and a reference unit 23. The definition processing unit 21 processes a table definition statement, and stores management information on the whole table, management information on columns, and the like, in the management information storage unit 2a. When there is an annotation that specifies that a column is rewritable, and the data type of the column indicates a fixed length, the definition processing unit 21 sets a rewritable flag of the column at “true”.

The update unit 22 executes update processing for the database 2b. When columns that are to be updated include a column that is not rewritable at the time of update of the record, the update unit 22 performs the update by addition. When all of the columns that are to be updated are rewritable, the update unit 22 performs the update by rewriting. For example, when the update of the rewritable column is the second time or more, the update unit 22 does not perform the update.

The reference unit 23 executes reference processing for the database 2b. The reference unit 23 determines whether the whole record is visible, in response to a reference request for the record, and does not reply to the reference request for the record when the whole record is not visible. When rewritable columns are included in the record, the reference unit 23 determines the visibility for each of the columns, and sets a default value to the record that is to be replied, for a column that is not visible.

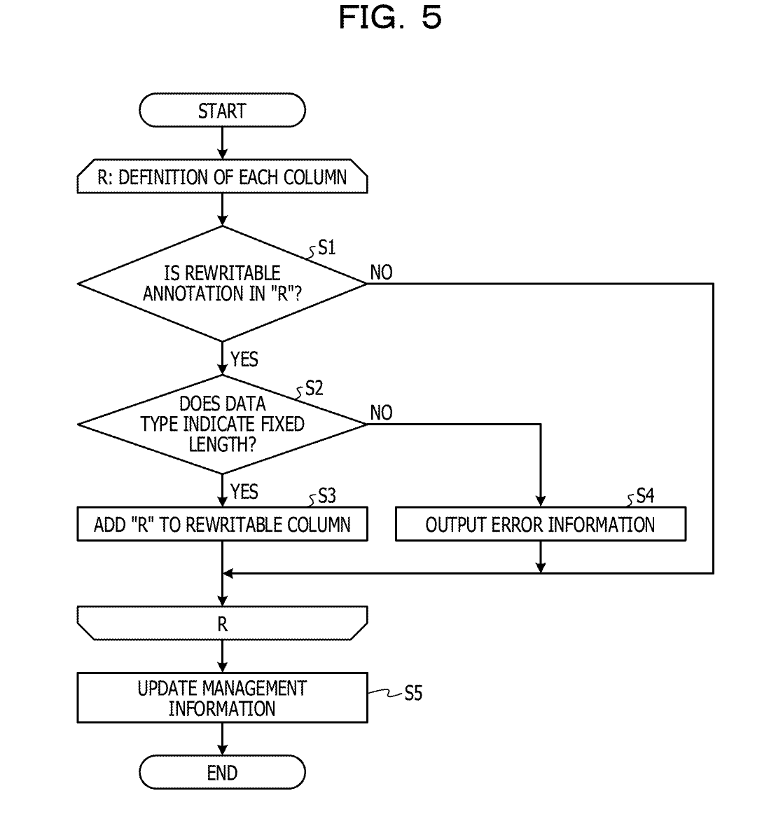

FIG. 5 illustrates exemplary processing in which a rewritable column is determined. The processing in which a rewritable column is determined may be part of the processing by the definition processing unit 21. As illustrated in FIG. 5, the definition processing unit 21 executes Operations S1 to S4 for each “R” by setting “R” as a definition of each of the columns.

For example, the definition processing unit 21 determines whether “R” has an annotation through which rewriting is allowed (Operation S1), and the next column is processed when the “R” has no annotation through which rewriting is allowed. When the “R” has an annotation through which rewriting is allowed, the definition processing unit 21 determines whether a data type of the column indicates a fixed length (Operation S2).

When the data type of the column indicates a fixed length, the definition processing unit 21 adds “R” to the rewritable column (Operation S3), and outputs error information (Operation S4) when the data type of the column does not indicate a fixed length.

When Operations S1 to S4 end for all “R”, the definition processing unit 21 updates the management information with reference to information on the rewritable columns (Operation S5).

As described above, the definition processing unit 21 determines a rewritable column based on the definition of each of the columns, and thus the database management device 2 performs update and reference of the rewritable column.

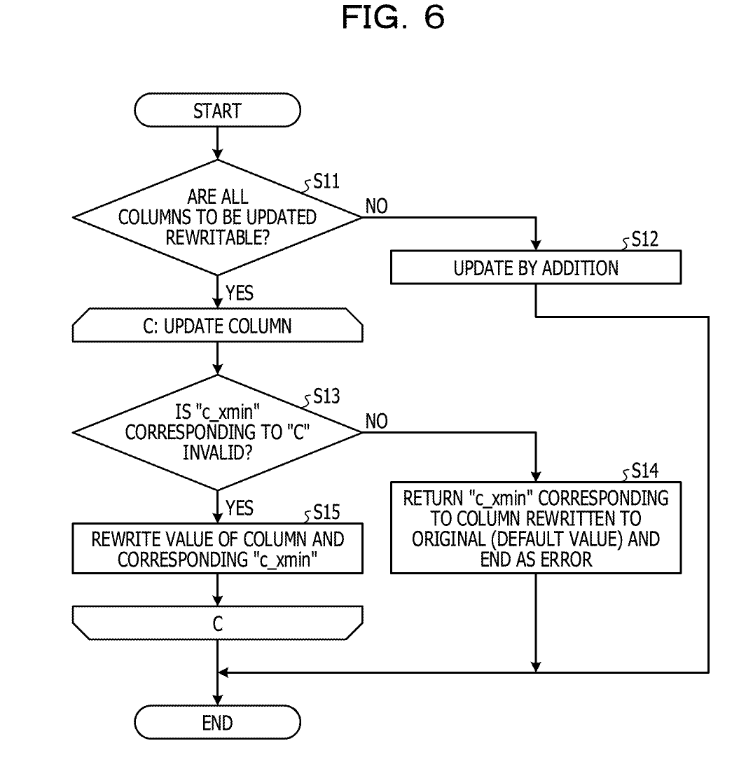

FIG. 6 illustrates exemplary record update processing. As illustrated in FIG. 6, the update unit 22 determines whether all columns that are to be updated are rewritable (Operation S11), and performs update by addition (Operation S12) when a column that is not rewritable is included in the columns that are to be updated.

When all of the columns that are to be updated are rewritable, the update unit 22 executes Operations S13 to S15 for each “C” by setting “C” as an update column. For example, the update unit 22 determines whether “c_xmin” corresponding to “C” is invalid (Operation S13), when “c_xmin” is not invalid, “c_xmin” corresponding to the column that has been rewritten so far is returned to the initial state, and the flow ends as an error (Operation S14). Returning the “c_xmin” to the initial state indicates that “c_xmin” is returned to a default value.

When “c_xmin” corresponding to “C” is invalid, the update unit 22 rewrites the value of the column and the corresponding “c_xmin” (Operation S15). The update unit 22 executes Operations S13 to S15 for all “C”, and the record update processing ends.

As described above, the update unit 22 may reduce rewriting of the rewritable column twice or more by determining whether “c_xmin” corresponding to the rewritable column is invalid.

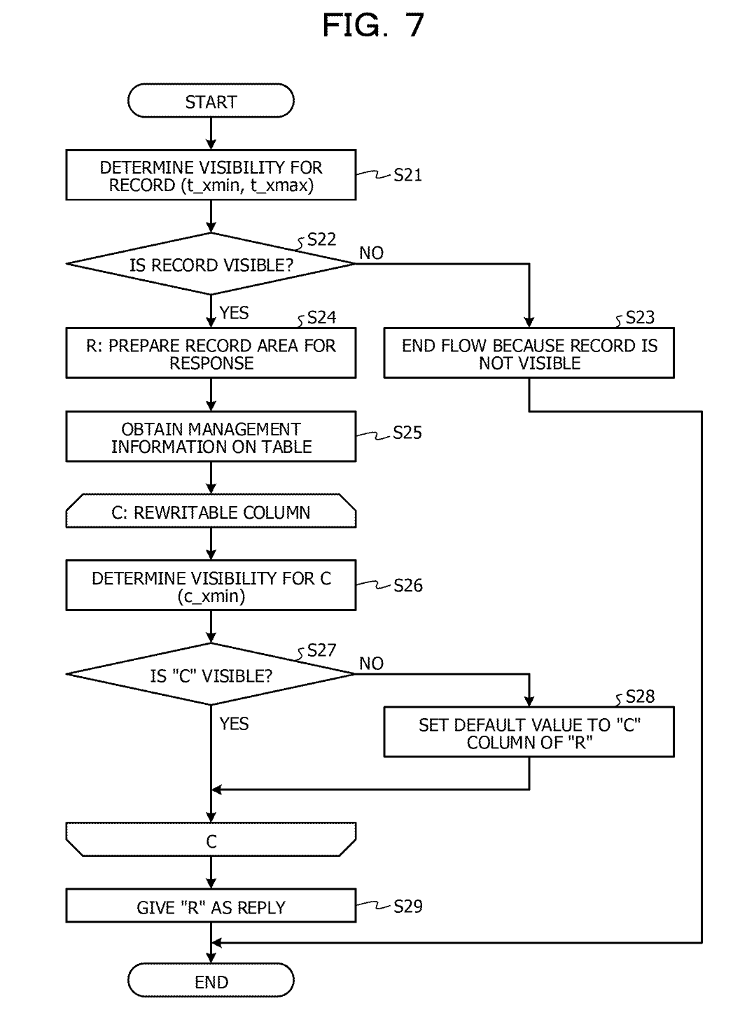

FIG. 7 illustrates exemplary record reference processing. As illustrated in FIG. 7, the reference unit 23 determines visibility for a record that is referred to (Operation S21). At that time, the reference unit 23 determines the visibility using “t_xmin” and “t_xmax” of the record that is referred to. The reference unit 23 determines whether the determination result indicates that the record is visible (Operation S22), and when the record is not visible, the flow ends (Operation S23).

When the record is visible, the reference unit 23 prepares a record area for response and sets the record area as “R” (Operation S24), and obtains management information on a table to which the record belongs (Operation S25). The reference unit 23 executes Operations S26 to S28 for each “C” by setting “C” as a rewritable column.

For example, the reference unit 23 determines visibility for “C” (Operation S26). The reference unit 23 determines the visibility by using “c_xmin” corresponding to “C”. The reference unit 23 determines whether the determination result indicates that “C” is visible (Operation S27), and when “C” is not visible, a default value is set to the C column of “R” (Operation S28).

The reference unit 23 executes Operations S26 to S28 for all “C”, and gives “R” as reply (Operation S29).

As described above, the reference unit 23 may give, as reply, only data that is allowed to be referred to by determining the visibility of the rewritable column in addition to the visibility of the record.

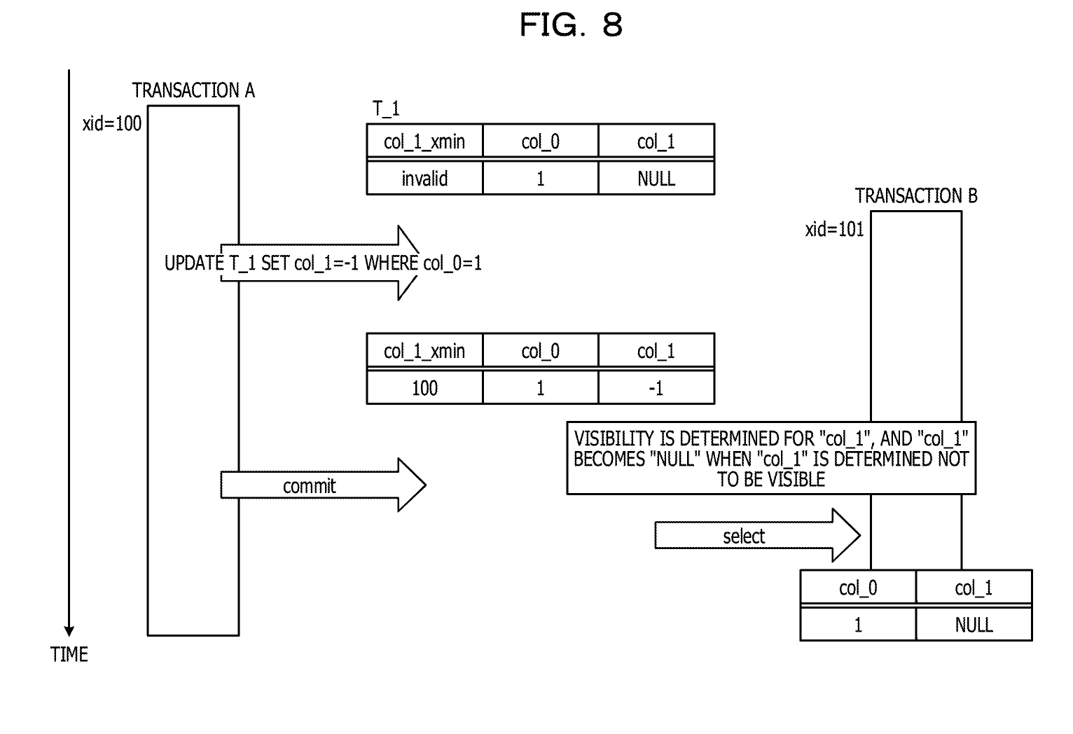

FIG. 8 illustrates a determination example of visibility of a rewritable column. In FIG. 8, “col_1” is a rewritable column, and “col_1_xmin” indicates a transaction ID of a transaction in which “col_1” has been rewritten.

As illustrated in FIG. 8, “col_1” of the first record of “T_1” is rewritten to “−1” by the transaction A the transaction ID of which is 100. When the transaction B the transaction ID of which is 101 refers to the first record of “T_1” during execution of the transaction A, the transaction ID (101) of the transaction B is larger than “col_1_xmin” (100). Therefore, “col_1” is determined not to be visible, and “NULL” that is the value of “col_1” is a reply to the transaction B.

As described above, the management information storage unit 2a stores management information on the whole table and columns. The management information on the columns includes the rewritable flag. In the case where the definition processing unit 21 accepts a column definition including “linear” as an annotation and the data type of the column indicates a fixed length, the definition processing unit 21 sets the rewritable flag at “true”. When all of rewritable flags of columns that are to be updated are “true”, the update unit 22 updates the record by rewriting. Thus, in the database management device 2, the overhead may be reduced as compared with a case in which all of the columns are updated by the write-once scheme.

The update unit 22 determines whether all of the rewritable flags of the columns that are to be updated are “true”, and writes a transaction ID of a transaction that has performed update to “c_xmin” corresponding to the column on which the rewriting has been performed. When the reference unit 23 refers to a rewritable column, the reference unit 23 determines visibility of the column using “c_xmin” and gives the data of the rewritable column as reply in the case where the column is visible. Thus, the database management device 2 may perform MVCC also for the rewritten column.

For example, when the configuration of the database management device 2 is realized by software, a database management program having a function similar to that of the database management device 2 may be provided.

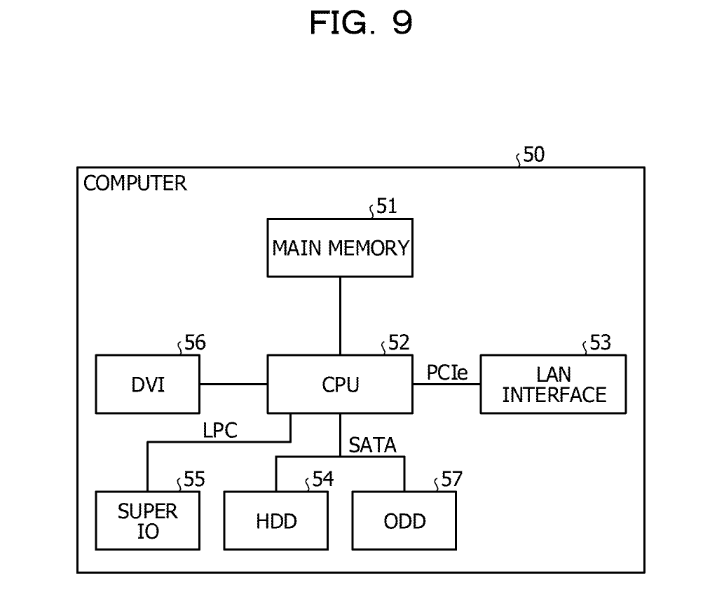

FIG. 9 illustrates an exemplary hardware configuration of a computer that executes a database management program. As illustrated in FIG. 9, a computer 50 includes a main memory 51, a central processing unit (CPU) 52, a local area network (LAN) interface 53, and a hard disk drive (HDD) 54. The computer 50 further includes a super input output (IO) 55, a digital visual interface (DVI) 56, and an optical disk drive (ODD) 57.

The main memory 51 may be a memory that stores a program, an in-progress result of the program, and the like. The CPU 52 may be a central processing device that reads the program from the main memory 51 and executes the program. The CPU 52 may include a chipset including a memory controller.

The LAN interface 53 may be an interface used to couple the computer 50 to another computer through a LAN. The HDD 54 may be a disk device that stores a program and data, and the super IO 55 may be an interface used to couple input devices such as a mouse and a keyboard to the computer 50. The DVI 56 may be an interface used to couple a liquid crystal display device to the computer 50, and the ODD 57 may be a device that performs reading and writing for a digital versatile disk (DVD).

The LAN interface 53 is coupled to the CPU 52 through PCI express (PCIe), and the HDD 54 and the ODD 57 are coupled to the CPU 52 through serial advanced technology attachment (SATA). The super IO 55 is coupled to the CPU 52 by low pin count (LPC).

For example, the database management program that is to be executed by the computer 50 may be stored in a DVD, read from the DVD by the ODD 57, and installed to the computer 50. For example, the database management program is stored in a database or the like of another computer system coupled to the computer 50 through the LAN interface 53, read from the database, and installed to the computer 50. The installed database management program is stored in the HDD 54, read into the main memory 51, and executed by the CPU 52.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A database management device comprising:
a memory that stores a database management program; and
a processor that executes processing based on the database management program, wherein
the processor:
accepts a table definition to which permission information is added, the permission information allowing one or more columns included in a table to be updated once;
stores management information on the table and the permission information in a management information storage; and
updates the table by a write-once scheme or a rewriting scheme based on the permission information.

2. The database management device according to claim 1, wherein
the processor performs multi-version concurrency control on a database including the table.

3. The database management device according to claim 1, wherein the processor:
determines whether an update of each of the one or more columns is a first-time update; and
updates the table by the rewriting scheme when the update of each the one or more columns is the first-time update.

4. The database management device according to claim 1, wherein the processor:
writes a transaction identifier that identifies a transaction in which update is performed, as column management information on a column of a record of the table on which a rewriting is performed, when the update is performed by the rewriting scheme;
determines whether the column is visible by using the column management information; and
gives a value of the column as reply when the column is visible.

5. The database management device according to claim 1, wherein the processor:
determines whether a data type of each of the one or more columns to which the permission information is added indicates a fixed length; and
stores the management information on the table in the management information storage with the permission information in a case where the data type indicates the fixed length.

6. An information processing system comprising:
a database management device that manages data; and
an information processing device that is coupled to the management device and processes the data,
wherein the database management device:
accepts a table definition to which permission information is added, the permission information allowing one or more columns included in a table to be updated once;
stores management information on the table and the permission information in a management information storage; and
updates the table by a write-once scheme or a rewriting scheme based on the permission information.

7. The information processing system according to claim 6, wherein
the database management device performs multi-version concurrency control on a database including the table.

8. The information processing system according to claim 6, wherein the database management device:
determines whether an update of each of the one or more columns is a first-time update; and
updates the table by the rewriting scheme when the update of each the one or more columns is the first-time update.

9. The information processing system according to claim 6, wherein the database management device:
writes a transaction identifier that identifies a transaction in which update is performed, as column management information on a column of a record of the table on which a rewriting is performed, when the update is performed by the rewriting scheme;
determines whether the column is visible by using the column management information; and
gives a value of the column as reply when the column is visible.

10. The information processing system according to claim 6, wherein the database management device:
determines whether a data type of each of the one or more columns to which the permission information is added indicates a fixed length; and
stores the management information on the table in the management information storage with the permission information in a case where the data type indicates the fixed length.

11. A database management method comprising:
accepting, by a processor, a table definition to which permission information is added, the permission information allowing one or more columns included in a table to be updated once;
storing management information on the table and the permission information in a management information storage; and
updating the table by a write-once scheme or a rewriting scheme based on the permission information.

12. The database management method according to claim 11, wherein
multi-version concurrency control on a database including the table is performed by the processor.

13. The database management method according to claim 11, further comprising:
determining whether an update of each of the one or more columns is a first-time update; and
updating the table by the rewriting scheme when the update of each the one or more columns is the first-time update.

14. The database management method according to claim 11, further comprising:
writing a transaction identifier that identifies a transaction in which update is performed, as column management information on a column of a record of the table on which a rewriting is performed, when the update is performed by the rewriting scheme;
determining whether the column is visible by using the column management information; and
giving a value of the column as reply when the column is visible.

15. The database management method according to claim 11, further comprising:
determining whether a data type of each of the one or more columns to which the permission information is added indicates a fixed length; and
storing the management information on the table in the management information storage with the permission information in a case where the data type indicates the fixed length.
